(19) United States
(12) Patent Application Publication
(10) Pub. No.: US 2011/0096820 A1
(43) Pub. Date: Apr. 28, 2011

(54) Modulation Evaluation System

(76) Inventors: Kevin Patrick Lavery, Sugarland, TX (US); Hari Pendurty, Pearland, TX (US)

(21) Appl. No.: 12/913,643

(22) Filed: Oct. 27, 2010

Related U.S. Application Data
(60) Provisional application No. 61/255,285, filed on Oct. 27, 2009.

(51) Int. Cl. H04B 17/00

(52) U.S. Cl. 375/224

(57) ABSTRACT

A modulation evaluation system associated with frequency modulations periods of a phase-locked loop is described. The system includes a first accumulator for accumulating clock edges a window of the frequency modulation periods; a second accumulator coupled to the first accumulator and operative for accumulating clock edges during whole periods of the frequency modulation periods; a dynamic enable control coupled to a first input associated with the first accumulator and a second input associated with the second accumulator, wherein the dynamic enable control selectively transmits a first enable signal that controls when the first accumulator accumulates clock edges and a second enable signal controls when the second accumulator accumulates clock edges, and accumulating clock edges enable modulation evaluation during production.

### CROSS REFERENCE TO RELATED APPLICATION(S)

The present application claims priority to jointly owned U.S. Provisional Application corresponding to application number 61/255,285 entitled “PLL MODULATION BIST.” This provisional application was filed on Oct. 27, 2009.

### DESCRIPTION OF RELATED ART

With the evolution of electronic systems, there is a continual demand for enhanced speed, capacity and efficiency in various areas including electronics, communications, and machinery. Some of this increased efficiency has been realized by modulating clocks within electronic systems using a phase locked loop, or PLL. Consequently, there remain unmet needs relating to effectively modulating clocks.

### BRIEF DESCRIPTION OF THE DRAWINGS

The modulation evaluation system may be better understood with reference to the following figures. The components within the figures are not necessarily to scale, emphasis instead being placed upon clearly illustrating the principles of the invention. Moreover, in the figures, like reference numerals designate corresponding parts or blocks throughout the different views.

FIG. 1 is an environmental drawing illustrating a system with several subsystems that have a modulation evaluation system (MES).

FIG. 2 is a block diagram of a representative subsystem illustrating interaction of the MES with other components within the subsystem.

FIG. 3A is a block diagram of a first implementation of the MES of FIG. 1.

FIG. 3B is a graphical representation illustrating behavior of signals associated with the MES of FIG. 3A.

FIG. 3C is a block diagram of an alternative implementation of the MES of FIG. 3A.

FIG. 4 is a block diagram of a first implementation of the MES of FIG. 1

While the modulation evaluation system is susceptible to various modifications and alternative forms, specific embodiments have been shown by way of example in the drawings and subsequently are described in detail. It should be understood, however, that the description herein of specific embodiments is not intended to limit the modulation evaluation system to the particular forms disclosed. In contrast, the intention is to cover all modifications, equivalents, and alternatives falling within the spirit and scope of the modulation evaluation system as defined by this document.

### DETAILED DESCRIPTION OF EMBODIMENTS

As used in the specification and the appended claim(s), the singular forms “a,” “an” and “the” include plural referents unless the context clearly dictates otherwise. Similarly, “optional” or “optionally” means that the subsequently described event or circumstance may or may not occur, and that the description includes instances where the event or circumstance occurs and instances where it does not.

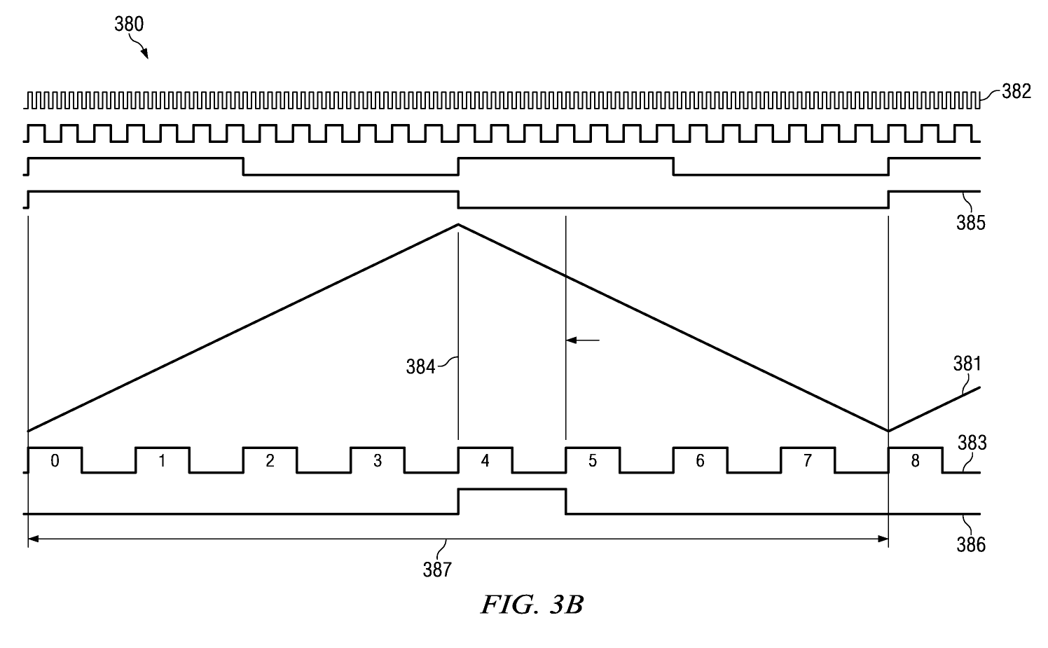

The modulation evaluation system 150 includes a dynamic enable control 303 that dynamically controls the enable of two accumulators; one accumulates clock edges during a window of the frequency modulation periods, while the other accumulator accumulates clock edges during whole periods of the frequency modulation periods (see waveform 387 in FIG. 3A). So, one accumulator is enabled for a subset of the time that the other accumulator is enabled. This is described in greater detail with reference to subsequent figures. User defined bit-fields may control some enables (e.g., enable on terminal 331) for the MES 150 and also reset the accumulators. The bit-field enable on terminal 331 is synchronized to the beginning of the modulation period based upon an input from the PLL on terminal 345 as shown with waveform 385. This synchronization means that an enable to accumulator 360 is active for whole modulation periods as described with reference to waveform 387. This synchronization also defines the period for which accumulator 370 is a subset. The enable to accumulator 370 is controlled with the signal on the terminal 359 and is a subset of the time defined on the terminal 349.

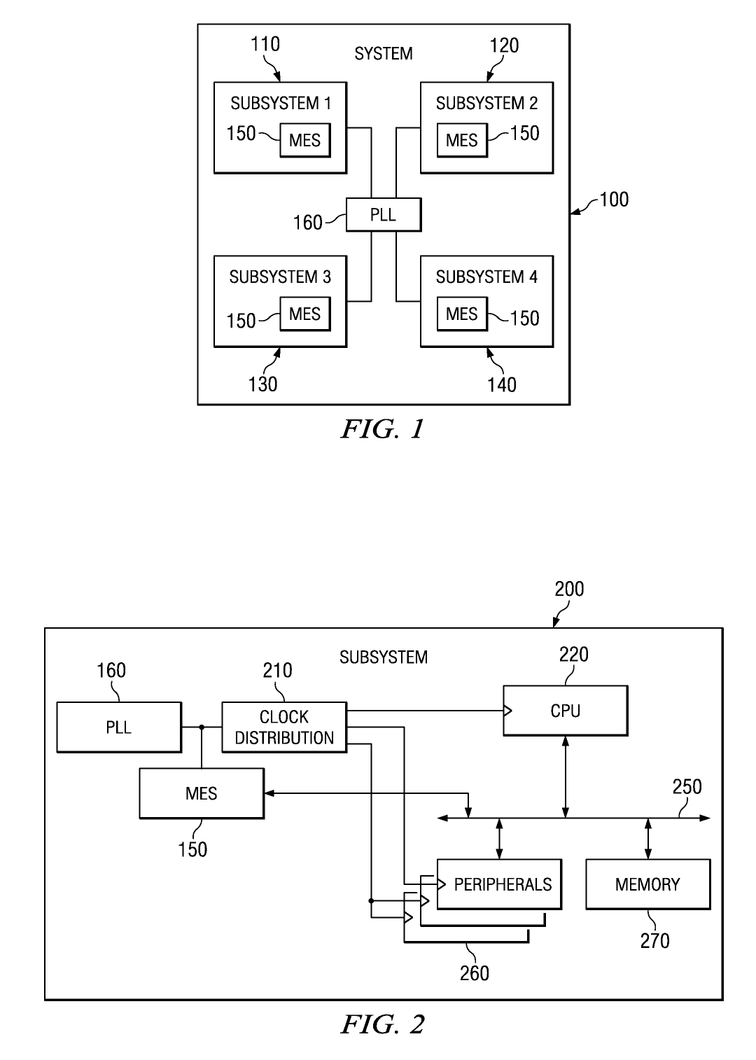

FIG. 1 is an environmental drawing illustrating a system 100 with several subsystems 110-140 that have a modulation evaluation system (MES) 150. In one example, the system 100 may be an automobile and the subsystems may represent either electrical or electro-mechanical subsystems within the automobile, such as the radio, braking system, or the like. As technology advances and the subsystems 110-140 shrink, electrical signals within these systems could interfere with each other. For example, operating subsystem 110, like the radio, may interfere with subsystem 120, which could me the car's braking system. To minimize potentially negative interference, the system 100 includes a phase lock loop (PLL) 160 that distributes the energy of electrical signals within these subsystems across various frequencies and produces lower energy. Lower energy then results in less interference among the subsystems. In FIG. 1, the PLL is shown as external to the subsystems 110-140, an alternative implementation may result if the PLL 160 is within one or more of these subsystem.

The PLL 160 distributes the energy across various frequencies using modulation. The MES 150 enables real-time evaluation of the PLL's modulation. By evaluating, modulation of the PLL 160 in real-time, corrective action may be implemented that varies the modulation to an appropriate level for safe operation of the appropriate subsystem. For example, the PLL 160 may have a different depth of modulation when the system is operational than originally anticipated. As the MES 150 receives a signal from the PLL, this system can assess whether the modulation is comparable to the desired modulation.

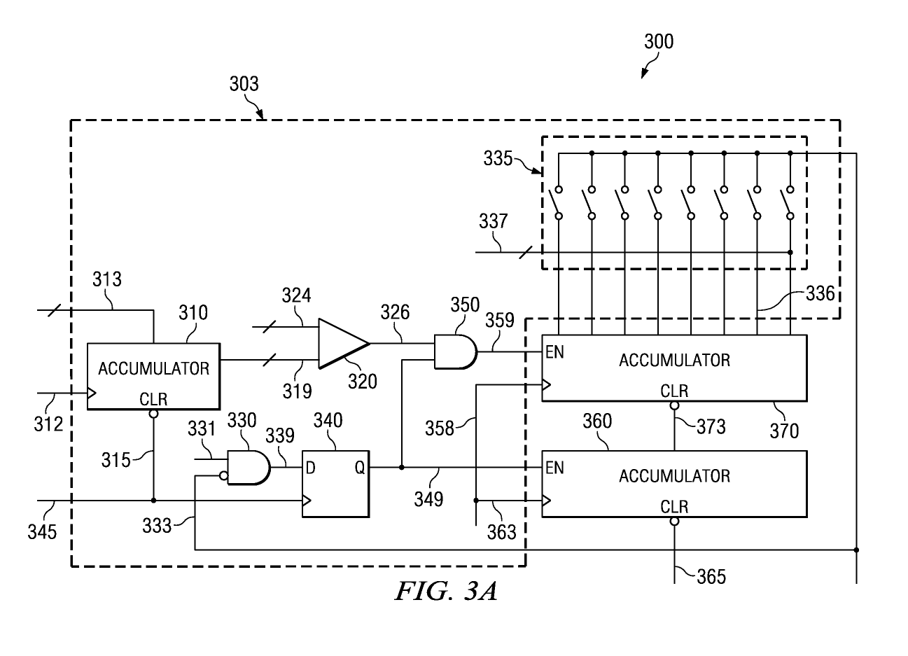

FIG. 2 is a block diagram of a representative subsystem 200 illustrating interaction of the MES 150 with other components within this subsystem. The subsystem 200 may be any one of the subsystems described with reference to FIG. 1. In this subsystem, the PLL 160 transmits a clock, or PLL, signal to the clock distribution device 210. This device may transmit a distributed clock signal to various other components, such as a central processing unit 220, or peripherals 240. Since the MES 150 is coupled to both the PLL 160 and the clock distribution device 210, it can monitor the PLL signal. Also, the MES 150 couples to a data transmission device 250, such as a bus. The CPU 220, peripherals 260, and memory 270 can receive signals from the data transmission device. Consequently, the MES 150 may transmit a flag, or alarm, when the modulation is inappropriate that may get routed to the appropriate component (e.g., CPU 220, peripherals 260, and memory 270) so corrective action may be taken.

The modulation evaluation system 150 includes a dynamic enable control 303 that dynamically controls the enable of two accumulators; one accumulates clock edges during a window of the frequency modulation periods, while the other accumulator accumulates clock edges during whole periods of the frequency modulation periods (see waveform 387 in FIG. 3A). So, one accumulator is enabled for a subset of the time that the other accumulator is enabled. This is described in greater detail with reference to subsequent figures. User defined bit-fields may control some enables (e.g., enable on terminal 331) for the MES 150 and also reset the accumulators. The bit-field enable on terminal 331 is synchronized to the beginning of the modulation period based upon an input from the PLL on terminal 345 as shown with waveform 385. This synchronization means that an enable to accumulator 360 is active for whole modulation periods as described with reference to waveform 387. This synchronization also defines the period for which accumulator 370 is a subset. The enable to accumulator 370 is controlled with the signal on the terminal 359 and is a subset of the time defined on the terminal 349.

Turn now to FIG. 3A, is a block diagram 300 of a first implementation of the MES 150 that includes a dynamic control enable 303 which may include all of the components within the dotted box that will be described individually. In this implementation, an accumulator 310 receives a system clock signal on the terminal 312 which is the input clock to the PLL shown as waveform 382 in FIG. 3B. In addition, the accumulator receives a counting signal, or modulation period counting signal. This figure is a graphical representation 380 illustrating behavior of the signals associated with the MES 150. The forms of the signals illustrated in this figure are representative and numerous implementations of the MES 150 may result by changing the form (e.g., shape, frequency, or the like) of one or more of these signals. The modulation of the PLL 160 may be represented by the waveform 381 that gradually changes over time. The input clock signal received at terminal 312 is represented by the waveform 382. Making this input clock signal fast increases the granularity modulation measurement.

The counting signal received terminal 319 is represented by the waveform 383. This waveform indexes a group of windows with the modulation waveform 381. For example, the waveform 383 has eight windows associated with a complete cycle of the waveform 381; four of these windows are during a rising section, while four windows are associated with a falling section. In addition to associating windows with the waveform 381, the windows are uniquely numbered, or indexed. That is, there is only one window within a cycle of the waveform 381 with the number four. And, this number may be associated with a specific region of the waveform 381, such as the 384. The counting signal received on terminal 319 (see FIG. 3A) is a dynamic signal that cycles through each of the indices associated with the windows on the waveform 383. In fact, this counting signal may increment on each rising edge of the waveform 383.

The accumulator 310 also receives a synchronization signal as a reset pulse on terminal 315. This synchronization signal (from which the pulse is derived) may be represented by the waveform 385 (see FIG. 3B). As illustrated in the figures, this waveform may be synchronized with the phases of the modulation waveform 381. The synchronization signal has a fixed relationship to the modulation waveform; in the figure, the synchronizing signal is high during a rising portion of this modulation waveform and may be low during a falling portion of the modulation waveform. Using this synchronization signal enables defining the beginning and midpoint of the modulation waveform 381. The accumulator 310 transmits a window index signal on the terminal 319 that reflects a particular window associated with the number of clocks accumulated, since the last reset. In one implementation, the counting signal received on the terminal 313 may be a 9-bit signal, while the window index signal applied to the terminal 319 may be an 8-bit signal. In addition, the accumulator 310 may be implemented as a pre-scaled register, or the like.

A comparator 320 receives the window index signal applied to the terminal 319. In addition, this comparator receives a window capture signal on the terminal 324 from a register bit-field; the register bit-field allows the user to define which window to measure. This window capture signal designates a specific window for making modulation measurements. For example, this window capture signal may be four if modulation measurements should be made in the region 384, described with reference to FIG. 3B. The comparator 320 applies a selected window signal to the terminal 326. This signal may be represented by the waveform 386 of FIG. 3B. This waveform may be high during one window, such as the window associated with the region 384. Since a window is associated with a specific portion of the modulation waveform 381, using the selected window signal facilitates only capturing modulation during a selected, repeatable portion of the waveform.

A logic component 330 receives a counter enable, or first enable signal, on the terminal 331. This enable signal may be received from a user-controlled bit field. The logic component also receives a feedback signal on the terminal 333 from the multi-selection device 335. An alternative implementation may result by removing this multi-selection device as illustrated in FIG. 3C. Instead of using the feedback signal on the terminal 333, this implementation may disable the measurement through a user controlled bit on terminal 331. Returning to FIG. 3A, the logic component 330 may be any one of a host of logic components, though shown as an AND gate with an inverted input on the terminal 333. The logic component 330 applies a logic, or second, enable signal to the terminal 339 that is received by the selection device 340. This selection device also receives the synchronization signal on terminal 345, or clock input, and transmits a third enable signal on the terminal 349 when the synchronization signal changes.

An accumulator 360 receives the third enable signal and the PLL signal on the terminal 349 and the terminal 363, respectively. This accumulator also receives a reset signal on a reset terminal 365. In one implementation, the accumulator 360 may be implemented as a Gray code counter using 32-bit registers, though other alternatives are equally applicable. With this configuration, the accumulator 360 is generally active while the third enable signal is high and is active, or accumulating, for a full modulation period. Moreover, using a Gray code counter adds robustness to the accumulator.

A second logic component 350 receives the selected window signal applied to the terminal 326 and the third enable signal applied to the terminal 349. Though indicated as an AND gate, this logic component may any type of logical component, such as an OR gate, NAND gate, or the like. In response to receiving these inputs, the logic component 350 applies a window enable signal to the terminal 359. An accumulator 370 receives the PLL signal on a terminal 358 and the window enable signal on the terminal 359. The accumulator 370, then accumulates edges from the PLL signal during the enabled period which is defined by the active window 386.

The enable during a window defined by 386 allows the PLL edges to accumulate only during a specific window of the modulation period. The frequency offset from the average frequency is therefore maintained as more samples are accumulated because it only accumulates during a defined portion of the modulation waveform. As a result, the accumulator 370 enables measuring the PLL's depth of modulation. Since the average frequency in a phase index approaches the instantaneous frequency as the index range increases. The MES 150 can discriminate smaller frequency difference as it evaluates over multiple modulation periods. This accumulator also receives a reset signal (along with the accumulator 360 on the terminal 373 from a user-controlled bit field. Like the accumulator 360, the accumulator 370 may be implemented as a Gray code counter.

The multi-switch device 335 may be a collection of individual switches 336 with a switch enable signal applied to the terminal 337. The number of switches within this multi-switch device may vary depending on the characteristics of the accumulator 370. For example, the multi-switch device 335 may include eight individual switches This switch enable signal may be synchronized with the changing bit such that the associated switch 336 closes and produces the feedback signal. This feedback signal gets routed back to the logic component 330. As a result, the system stops counting on a pre-defined number of edges in accumulator 370.

The block diagram 300 for the MES 150 enables effective measurement of the production, or real-time, modulation frequency for the PLL 160. To enable the production frequency measurement, this MES uses a series of accumulators (e.g., accumulator 360, accumulator 370) as gated counters that produce a digital result. These gated counters measure the modulation frequency during a specified portion of the waveform 381, such as the region 384. Using a specified portion makes the modulation frequency-offset predictable and distinguishable from the random jitter. In addition, the number of windows for a modulation period may vary. As a result, MES 150 can either produce a very precise measurement with a high degree of resolution or quickly produce a less precise modulation measures. Hence, the MES 150 enables a time versus resolution trade off.

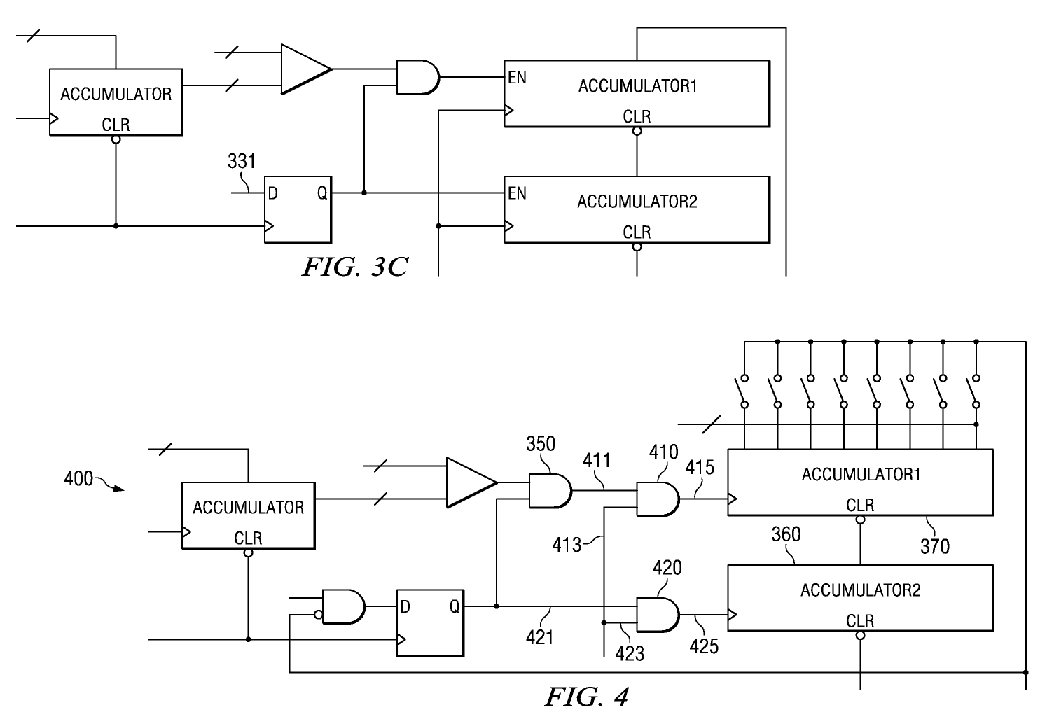

FIG. 4 is a block diagram 400 of another implementation of the MES 150. In this implementation, two additional logic components 410, 420 are included. The logic component 410 receives the window enable signal on terminal 411 and receives the PLL signal on the terminal 413. This logic component applies a first accumulator enable signal to the terminal 415, which is the clock input of the accumulator 370. The logic component 420 receives the third enable signal on the terminal 421 and receives the PLL signal on the terminal 423. The logic component 420 applies a second accumulator enable signal to the terminal 425, which is the clock input of the accumulator 360. In this implementation, the accumulators 360, 370 have a single enable input with a reset in contrast to the double enable input and reset described with reference to FIG. 3A. While the block diagram 300 applies an enable to an accumulator, 400 directly enables the clock with the accumulator always enabled. The functionality is the same with these two different implementations

While various embodiments of the modulation evaluation system have been described, it may be apparent to those of ordinary skill in the art that many more embodiments and implementations are possible that are within the scope of this system. Although certain aspects of the modulation evaluation system may be described in relation to specific techniques or structures, the teachings and principles of the present system are not limited solely to such examples. All such modifications are intended to be included within the scope of this disclosure and the present modulation evaluation system and protected by the following claim(s).

1. A modulation evaluation system associated with frequency modulations periods of a phase-locked loop, comprising:
a first accumulator for accumulating clock edges a window of the frequency modulation periods;
a second accumulator coupled to the first accumulator and operative for accumulating clock edges during whole periods of the frequency modulation periods;
a dynamic enable control coupled to a first input associated with the first accumulator and a second input associated with the second accumulator,
wherein
the dynamic enable control selectively transmits a first enable signal that controls when the first accumulator accumulates clock edges and a second enable signal controls when the second accumulator accumulates clock edges, and
accumulating clock edges enables modulation evaluation during production.
